(19) United States
(12) Patent Application Publication
(10) Pub. No.: US 2024/0172112 A1
(43) Pub. Date: May 23, 2024

(54) INTELLIGENT STATE TRANSITION PROCEDURE FOR RADIO ACCESS NETWORK

(71) Applicant: Nokia Solutions and Networks Oy, Espoo (FI)

(72) Inventors: Xuju ZHU, Hangzhou (CN); Chuanzong ZHANG, Hangzhou (CN)

(21) Appl. No.: 18/551,250

(22) PCT Filed: Apr. 8, 2021
(86) PCT No.: PCT/CN2021/085997

§ 371 Date: Sep. 19, 2023

(51) Int. Cl. H04W 52/02; H04L 5/00

(52) U.S. Cl. CPC H04W 52/0216; H04L 5/0091

(57) ABSTRACT

Example embodiments of the present disclosure relate to devices, methods, apparatuses and computer readable storage media for state transition of a radio access network (RAN). In example embodiments, a second device obtains a first plan for state transition of a RAN. The first plan is determined based on a first set of state-related metrics of the RAN for first time duration, and the first plan comprises a first expected state of the RAN for a time period. Further, the second device obtains a second set of state-related metrics of the RAN for second time duration shorter than the first time duration and determines, from the first expected state, a target state of the RAN for the time period. The determination of the target state is based on at least one of prioritization associated with the first expected state or the second set of state-related metrics of the RAN.

### FIELD

Example embodiments of the present disclosure generally relate to the field of communications, and in particular, to devices, methods, apparatuses and computer readable storage media for state transition of a radio access network (RAN).

### BACKGROUND

Open Radio Access Network (O-RAN) ALLIANCE is an organization to transform a radio access network (RAN) towards the open, intelligent, virtualized and fully interoperable RAN. Empowered by principles of intelligence and openness, the O-RAN architecture is the foundation for building the virtualized RAN on an open hardware and cloud, with embedded Artificial Intelligence powered (AI-powered) radio control.

The architecture based on standards defined by O-RAN ALLIANCE fully supports and is complimentary to standards promoted by 3rd Generation Partnership Project (3GPP) and other industry standard organizations. The O-RAN architecture enhances the traditional RAN functions with embedded intelligence by introducing a hierarchical RAN Intelligent Controller (RIC) with the A1 and E2 interfaces.

State transition is a common scenario in a RAN. For example, switching of energy saving modes is a typical state-transition scenario. There is a need to design an intelligent state transition procedure of a RAN with the assistance of a RIC under the O-RAN architecture.

### SUMMARY

In general, example embodiments of the present disclosure provide devices, methods, apparatuses and computer readable storage media for state transition of a radio access network (RAN).

In a first aspect, a first device is provided which comprises at least one processor and at least one memory including computer program code. The at least one memory and the computer program code are configured to, with the at least one processor, cause the first device to obtain a first set of state-related metrics of a RAN for first time duration. The first device is further caused to determine, based on the first set of state-related metrics of the RAN, a first plan for state transition of the RAN. The first plan comprises a first expected state of the RAN for a time period. The first expected state is to be used to determine a target state of the RAN for the time period.

In a second aspect, a second device is provided which comprises at least one processor and at least one memory including computer program code. The at least one memory and the computer program code are configured to, with the at least one processor, cause the second device to obtain a first plan for state transition of a RAN. The first plan is determined based on a first set of state-related metrics of the RAN for first time duration, and the first plan comprises a first expected state of the RAN for a time period. The second device is further caused to obtain a second set of state-related metrics of the RAN for second time duration shorter than the first time duration and determine, from the first expected state, a target state of the RAN for the time period. The determination of the target state is based on at least one of prioritization associated with the first expected state or the second set of state-related metrics of the RAN.

In a third aspect, a third device is provided which comprises at least one processor and at least one memory including computer program code. The at least one memory and the computer program code are configured to, with the at least one processor, cause the third device to obtain a target state of the RAN for a time period. The third device is further caused to perform an act based on at least one of prioritization associated with the target state, or one or more conditions of transition to the target state in the time period.

In a fourth aspect, a method is provided at a first device. In the method, the first device obtains a first set of state-related metrics of a RAN for first time duration. Based on the first set of state-related metrics of the RAN, the first device determines a first plan for state transition of the RAN. The first plan comprises a first expected state of the RAN for a time period. The first expected state is to be used to determine a target state of the RAN for the time period.

In a fifth aspect, a method is provided at a second device. In the method, the second device obtains a first plan for state transition of a RAN. The first plan is determined based on a first set of state-related metrics of the RAN for first time duration, and the first plan comprises a first expected state of the RAN for a time period. Further, the second device obtains a second set of state-related metrics of the RAN for second time duration shorter than the first time duration and determines, from the first expected state, a target state of the RAN for the time period. The determination of the target state is based on at least one of prioritization associated with the first expected state or the second set of state-related metrics of the RAN.

In a sixth aspect, a method is provided at a third device. In the method, the third device obtains a target state of the RAN for a time period. The third device then performs an act based on at least one of prioritization associated with the target state, or one or more conditions of transition to the target state in the time period.

In a seventh aspect, there is provided an apparatus comprising means for performing the method according to the fourth, fifth or sixth aspect.

In an eighth aspect, there is provided a computer readable storage medium comprising program instructions stored thereon. The instructions, when executed by a processor of a device, cause the device to perform the method according to the fourth, fifth or sixth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a signaling flow of a state transition procedure of a RAN according to some example embodiments of the present disclosure;

FIG. 3 illustrates an example process of state transition of a RAN according to some example embodiments of the present disclosure;

FIG. 4 illustrates a flowchart of an example method according to some example embodiments of the present disclosure;

FIG. 5 illustrates a flowchart of an example method according to some other example embodiments of the present disclosure;

FIG. 6 illustrates a flowchart of an example method according to yet some example embodiments of the present disclosure; and

FIG. 7 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

As discussed above, state transition is a common scenario in a RAN. There are various state machines in a RAN. For example, the switching of energy saving modes is an example state-transition scenario. There could be various states, and the state transition requires monitoring of state-transition conditions. The O-RAN architecture enhances the traditional RAN functions with embedded intelligence by introducing a hierarchical RAN Intelligent Controller (RIC) and thus enables the introduction of intelligence into this scenario.

The state transition in an intelligent RAN needs the cooperation of O-RAN functional components. For example, there is a need for proper functionality splitting among the O-RAN functional components. Moreover, there is a need to define a cooperation procedure for synchronization between the O-RAN functional components.

Example embodiments of the present disclosure provide an intelligent state transition procedure for a RAN. The procedure integrates long-term prediction for state transition based on short-term state-related metrics of the RAN, short-term prediction of state transition based on short-term state-related metrics of the RAN and a reactive module at the RAN. In the context of the present disclosure, the long-term state-related metrics refers to state-related metrics that are measured by the RAN for longer time duration such as a week, a day and a hour, and the short-term state-related metrics refers to state-related metrics that are measured by the RAN for shorter time duration such as 10 ms to 1 s. The state may comprise any state of the RAN, for example, in terms of network energy saving, loads, load-balancing. resource management, interference detection and mitigation, mobility management. connection control. Quality of Service (QOS) management and the like. The state related metrics may comprise various metrics such as system-load related metrics and Key Performance Indicator (KPI) related metrics. The KPIs may include data rate, traffic capacity. user density, latency, reliability, and availability and the like.

According to example embodiments of the present disclosure, in the intelligent state transition procedure, a plan (referred to as a first plan) for state transition of the RAN is determined based on a set of state-related metrics (referred to as a first set of state-related metrics) of the RAN for the longer time duration. Herein, the first plan will also be referred to as a long-term plan, which means that the plan is made based on the long-term state-related metrics. The first plan comprises an expected state (referred to as a first expected state) of the RAN for a time period. The time period may be five minutes, ten minutes, one hour or the like. From the first expected state, a target state of the RAN for the time period is determined based on a priority rule for the long-term plan and/or the short-term state-related metrics of the RAN. At the RAN, an act is performed based on a priority rule for the target state and/or related state-transition conditions.

This procedure can be implemented in the O-RAN architecture. In some example embodiments, the long-term prediction may be responsible for the long-term prediction with the long-term state related metrics from the RAN as an input and a long-term plan for the state transition of the RAN as an output. The Near-RT RIC may be responsible for the short-term prediction with the short-term state related metrics from the RAN. Moreover, the Near-RT RIC makes a decision with inputs including the first expected state of the long-term prediction and the short-term state related metrics and with an output of the target state. A RAN Network Element (NE) such as a centralized unit (CU) or a distributed unit (DU) may be responsible for taking actions according to the target state and at the same time by taking some or all of state-transition conditions into consideration.

This procedure can be implemented in the O-RAN architecture. In this case, a non-real-time (non-RT) RIC is responsible for the long-term prediction with long-term state related metrics from the RAN as an input and a long-term plan of state transition as an output. The near-RT RIC is responsible for short-term prediction with short-term state related metrics from the RAN. The near-RT RIC is also responsible for making decision whether state transition is needed or not, with inputs including an expected state of the short-term prediction, an expected state of the long-term plan, and state related metrics like KPIs and with an output of the expected state. The RAN Network Element (NE) such as a centralized unit (CU) or a distributed unit (DU) is responsible for taking actions according to an indication of state transition from a near-RT RIC and at the same time taking all the state-transition conditions into consideration.

This intelligent state transition procedure for a RAN may utilize the enhancement of the O-RAN architecture to the traditional RAN functions and is easy to be standardized into the O-RAN procedures. The procedure splits the functionality of controlling the state transition of the RAN well among the O-RAN functional components and therefore is more effective and efficient.

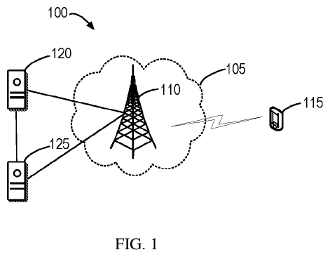

FIG. 1 shows an example environment 100 in which example embodiments of the present disclosure can be implemented.

The environment 100 comprises a RAN 105 in which a device 110 such as a base station such as a New Radio NodeB (such as gNB) or other network elements (NEs) communicates with a terminal device 115 such as user equipment (UE). The communication between the NE 110 and the terminal device 115 may be performed using any suitable wireless technologies that already exist or will be developed in the future. The scope of the present disclosure will not be limited in this regard.

The device 110 may be implemented by any device in the RAN 105 and may have any suitable structures. For example, the device 110 may be implemented by a gNB with a baseband unit (BBU) and a remote radio unit (RRU) that can communicate with each other via an optical fiber or cable. In this example, the RRU can communicate with the terminal device 115 in a wireless way. In some example embodiments, the BBU may be divided into a central unit (CU) and a distributed unit (DU).

As shown in FIG. 1, the environment 100 further comprises two devices 120 and 125 to control state transition of the RAN 105. It is to be understood that the first and second device 120 and 125 are shown outside the RAN 105 only for the purpose of illustration, without suggesting any limitation. As an example, the two devices 120 and 125 may be located within or at the edge of the RAN 105. As another example, either or both of the two devices 120 and 125 may be implemented by a core network devices outside the RAN 105.

In some example embodiments, the two devices 120 and 125 may be implemented respectively by a Non-RT RIC and a Near-NT RIC (which may constitute a RIC together) as edge computing devices of the RAN 105. The Non-RT RIC is an entity or functionality developed by the O-RAN Alliance to implement Intent-based management and built on principles of automation and Artificial Intelligence (AI) and Machine learning. The Near-RT RIC may be compatible with legacy Radio Resource Management (RRM) and used to enhance the performance in terms of load-balancing, Radio Bearer (RB) management, interference detection and mitigation or the like.

In the context of the present disclosure, for the purpose of discussion, the devices 120 and 125 will be referred to as a first device 120 and a second device 125, respectively. The device 110 in the RAN 105 will be referred to as a third device 110.

In some example embodiments, the first and second devices 120 and 125 both obtain state-related metrics from the third device 110 of the RAN 105. The first device 120 performs the long-term prediction to determine a long-term plan including an expected state based on the state-related metrics of the RAN 105 for longer time duration (referred to as first time duration). The second device 120 performs the short-term prediction based on the state-related metrics of the RAN 105 for shorter time duration (referred to as second time duration) to determine a target state from the expected state based on a priority rule of the expected state as well as the short-term state-related metrics from the RAN 105. In the context of the present disclosure. the long-term prediction refers to state transition prediction based on the long-term state related metrics, and the short-term prediction refers to state transition prediction based on the short-term state related metrics.

The third device 110 has a reactive module to perform an action upon an indication of the target state from the second device 120. The reactive module may be implemented at the third device 110 in any suitable form. For example, in the example embodiments where the third device 110 is implemented by a base station with a BBU and a RRU, the reactive module may be implemented by the BBU. If the BBU is divided into a CU and a DU, the reactive module may be implemented by either the CU or DU. The reactive module may be implemented by hardware or special purpose circuits, software, logic or any combination thereof at the third device 110.

It is to be understood that the first, second and third devices 120, 125 and 110 are shown in FIG. 1 to be separate from each other only for the purpose of illustration. In some example embodiments, two or more of the three devices may be integrated into one physical entity or device. In some example embodiments, the first and second devices 120 and 125 may be integrated into a RIC. Accordingly, the long-term prediction and the short-term prediction may be both implemented by the RIC integrated with the functions of the Non-RT RIC and the Near-NT RIC. In some other example embodiments, the three devices 110, 120 and 125 may be integrated into a base station such as a gNB within the RAN 105. In this example, the long-term prediction, the short-term prediction and the reactive module are all implemented at the base station, but may be implemented by separate functionality modules of the base station.

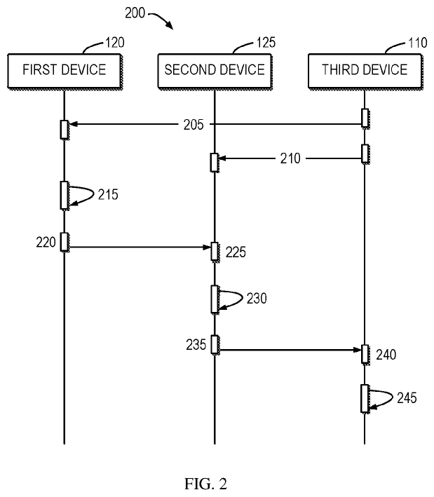

FIG. 2 shows a signaling flow of a state transition procedure 200 of the RAN 105 according to some example embodiments of the present disclosure.

In the procedure 200 as shown in FIG. 2, the first device 120 (for example, the Non-RT RIC) obtains (205) from the third device 110 (for example, a gNB) of the RAN 105 a first set of state-related metrics of the RAN 105 for the longer first time duration. The first time duration may be an hour, a day, a week or longer duration. The state-related metrics may be related to any state machines of the RAN 105. For example, the metrics may comprise system-load related metrics and KPI related metrics. In some example embodiments, the KPI related metrics may be mandatory metrics to be reported from the RAN 105 to the first device 120.

The metrics may be reported or updated from the RAN 105 periodically. For example, the first device 120 may receive state related metrics from the RAN 105 every ten seconds and gather the received metrics in one day as the first set of state related metrics. It is also possible that the metric report from the RAN 105 is triggered by a request from the first device 120 or other trigger events.

As shown in FIG. 2, the second device 125 (for example, the Near-NT RIC) obtains (210) from the third device 110 a second set of state-related metrics of the RAN 105 for the shorter second time duration. The second time duration may be one or two hours or shorter duration. Accordingly, the second device 125 may watch on the state related metrics in a shorter loop. The second set of state-related metrics may be reported or updated from the RAN 105 periodically or in response to a trigger event such as a request from the second device 125.

In the procedure 200, based on the first set of state-related metrics obtained (220) from the third device 110, the first device 120 determines (215) a first plan for state transition of the RAN 105. The first plan comprises a first expected state of the RAN 105 for a time period that may be five minutes, ten minutes, one hour or the like. The first plan may be determined by the long-term prediction based on the historical state related metrics. The long-term prediction may be performed by the first device 120 hourly, daily or weekly. Accordingly, the first time duration of the first set of state-related metrics may be no shorter than an hour, a day or a week.

As an example, the first device 120 may use the state related metrics in the past day to determine the first plan for state transition of the RAN 105 in the next day. The first plan may be represented in any suitable form. In some example embodiments, the first plan may be represented by a mapping table with a column storing expected states and another column storing different time periods of a day.

Then, the first device 120 sends (235) to the second device 125 an indication of the first plan for the state transition of the RAN 105. For example, the first device 120 may send to the second device 125 the mapping table between the expected states and the different time periods as the first plan.

In some example embodiments, the first device 120 may send an indication of prioritization associated with the first expected state to the second device 125 to indicate that the first expected state should be followed. For example, the first device 120 may use a further column in the mapping table to store an indication whether the corresponding expected state is mandatory (for example, labeled with “MUST”) or not. In some other example embodiments, the prioritization associated with the first expected state may be predefined. For example, it may be predefined that the first plan based on the long-term state related metrics is prioritized. Accordingly, the first expected state included in the first plan will be prioritized according to the prioritization of the first plan.

After the second device 125 receives (225) the first plan of the state transition from the first device 120, the second device 125 determines (230) a target state of the RAN 105 for the time point from the first expected state included in the first plan. The target state is determined by considering the prioritization associated with the first expected state and/or the second set of state-related metrics of the RAN for the shorter second time duration.

For example, the second device 125 may check the prioritization associated with the first expected state first. If the first expected state is labeled with “MUST” in the mapping table representing the first plan, or if the first plan is predefined to be prioritized, the second device 125 may determine that the target state of the RAN 105 follows the first expected state.

In some example embodiments, if the first plan is not mandatory, the second device 125 may perform the short-term prediction based on the second set of state related metrics to determine a plan (referred to as a second plan) for state transition of the RAN based on the second set of state-related metrics of the RAN for the shorter second time duration. The second plan comprises an expected state (referred to as a second expected state) of the RAN for the time period. There may be a decision module in the second device 125 which takes all the inputs from the first plan as well as the second plan and outputs a target state for the time period. The decision module may also take a set of state related metrics (referred to as a third set of state related metrics) for time duration (referred to as third time duration) shorter than the first time duration or even the second time duration for fine tuning of the target state.

The decision module may be implemented at the second device 125 in any suitable way. For example, the decision module may make the decision using machine learning algorithms. The decision module may be implemented by hardware or special purpose circuits, software, logic or any combination thereof at the second device 125.

Then, as shown in FIG. 2, the second device 125 sends (235) to the third device 110 an indication of the target state of the RAN 105 for the time period. After the third device 110 receives (240) the indication of the target state, the third device 110 performs (245) an action accordingly.

In some example embodiments, the third device 110 may take the indication of the target state as a mandatory instruction if the target state is prioritized. The prioritization of the target state may be predefined or indicated by the second device 125. For example, it may be defined that the third device 110 may report state transition related conditions to the first or second device 120 or 125 and the first or second device 120 or 125 is responsible for checking the conditions of transition to the target state. In this example, the third device 110 could be the executor of the state transition only without any check if all the metrics and conditions have been reported to the first and second devices 120 and 125.

In some other example embodiments, the indication of the target state from the second device 125 may be considered by the third device 110 as notification of a state change. The third device 110 may check whether the target state could be applied or not. For example, the third device 110 may check whether one or more conditions of transition to the target state are satisfied. If all the conditions are satisfied, the third device 110 may transmit to the target state in the time period. It may be also possible that the third device 110 performs the state transition when only some conditions are satisfied depending on the specific implementations.

As discussed above, the separate arrangement of the three devices 110, 120 and 125 is only an example implementation. In some example embodiments, the first and second devices 120 and 125 may be integrated into one physical entity. For example, the long-term prediction could also be implemented by the second device 125 such as the Near-RT RIC 135. In this example, the second device 125 determines the first plan including the first expected state based on the first set of state related metrics for the longer first time duration and then determines the target state from the first expected state as well as the second set of state related metrics for the shorter second time duration.

In some other example embodiments, the three devices 110, 120 and 125 may be integrated into one physical entity. For example, the long-term prediction and the short-term prediction may be implemented by the third device 110 inside the RAN 105.

In this example, the third device 110 determines the first plan including the first expected state based on the first set of state related metrics for the longer first time duration, and determines the target state from the first expected state as well as the second set of state related metrics for the shorter second time duration, and then determine whether the target state is applicable or not.

It is to be understood that the timing of the signaling flow is shown in FIG. 2 only for the purpose of illustration, without suggesting any limitation. For example, the obtaining of the state related metrics by the first and second devices 120 and 125 are shown at the beginning of the procedure 200 only for the purpose of illustration. It is possible that the obtaining of the state related metrics are performed before and after the long-term prediction and short-term prediction. For example, after the first device 120 determines (215) the first plan for state transition of the RAN 105, the first device 120 may obtain from the third device 110 of the RAN 105 further state related metrics for further long-term prediction. It is also possible that the second device 125 obtains the state related metrics from the third device 110 after receiving (225) the indication of the first plan from the first device 120.

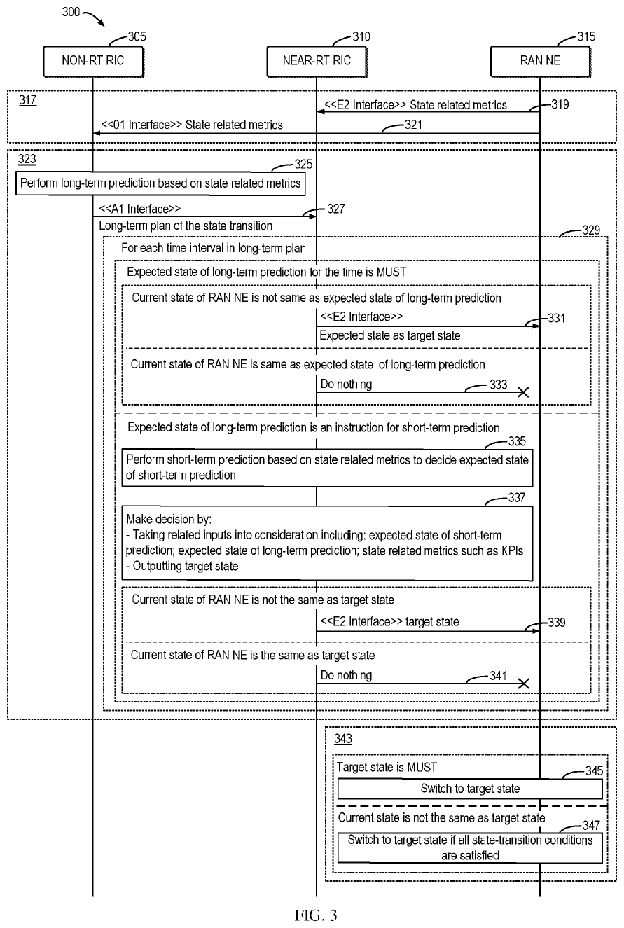

FIG. 3 shows an example process 300 of state transition of the RAN 105 according to some example embodiments of the present disclosure.

In this example, the first device 120 is implemented by a non-RT RIC 305, the second device 125 is implemented by a Near-RT RIC 310, and the third device 110 is implemented by a RAN NE 315.

As shown in FIG. 3, in a metric reporting phrase 317, the RAN NE 315 sends (319) state-related metrics to the Near-RT RIC 310 via the E2 interface. The RAN NE 315 also sends (321) state-related metrics to the non-RT RIC 305 via the 01 interface.

In a state transition determination phrase 323, the non-RT RIC 305 performs (325) the long-term prediction based on state related metrics from the RAN NE 315 to determine a plan (for example, the first plan) for the state transition of the RAN 105 including an expected state (for example, the first expected state). For example, the non-RT RIC 305 may do the long-term prediction hourly, daily or weekly based on the state relate metrics for very long duration such as a day or a week. Then, the non-RT RIC 305 delivers (327) an indication of the plan to the Near-RT RIC 310 via the A1 interface. The plan for the state transition may be delivered according to the long-term prediction periodicity, for example, every hour, every day or every week. The long-term plan may be represented as a mapping table with one column storing the expected states and another column storing the corresponding time periods. The mapping table may include a further column storing the prioritization associated with the respective expected states (for example, labeled by “MUST”) to indicate that the expected state labeled with “MUST” should be followed.

The Near-RT RIC 310 watches (329) on the state related metrics in a shorter loop. For each time period, the Near-RT RIC 310 checks the plan for the state transition first. As shown, if an expected state (for example, the first expected state) for a time period is labeled by “MUST” in the mapping table. then the Near-RT RIC 310 delivers (331) an indication of the expected state as a target state to the RAN NE 315 via the E2 interface in the case that the current state of the RAN NE 315 is not the same as the expected state. If the current state of the RAN NE 315 is the same as the expected state, the Near-RT RIC 310 will do (333) nothing.

If the expected state is not labeled by “MUST” in the mapping table, the Near-RT RIC 310 will consider the expected state as an instruction for the short-term prediction. As shown, the Near-RT RIC 310 performs (335) the short-term prediction based on the state related metrics to decide an expected state of the short-term prediction (for example, the second expected state). Then, the Near-RT RIC 310 makes (337) a decision by taking the related inputs into consideration including the second expected state of the short-term prediction, the first expected state of the long-term prediction and some state related metrics such as KPIs and outputting the target state. For example, there is a decision module in the near-RT RIC 310 which takes all the inputs from the long-term plan and the short-term prediction as well as all the state related metrics and outputs the target state.

Then, the Near-RT RIC 310 may deliver (339) an indication of the target state to the RAN NE 315 via the E2 interface if the current state of the RAN NE 315 is not the same as the target state. If the current state of the RAN NE 315 is the same as the target state, the Near-RT RIC 310 will do (341) nothing.

In a reactive phrase 343, the RAN NE 315 should take the indication of the target state indication from the Near-RT RIC 310 as an instruction to check whether the target state could be applied or not. The RAN NE 315 may save (or store) the target state. If the target state is labeled with “MUST” in its indication, which means that the target state is prioritize and thus should be followed, the RAN NE 315 switches (345) to the target state in the time period. Otherwise, the RAN NE 315 may check whether the current state is the same as the target state. If the current state is not the same, the RAN NE 315 switches to the target state if all state-transition conditions are satisfied.

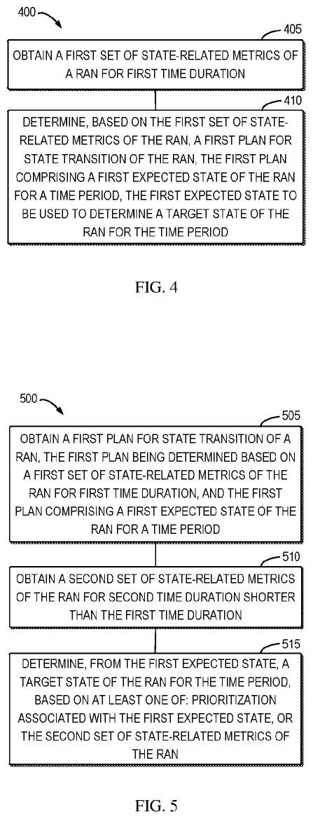

FIG. 4 shows a flowchart of an example method 400 according to some example embodiments of the present disclosure. The method 400 can be implemented at the first device 120 as shown in FIG. 1. For the purpose of discussion, the method 400 will be described with reference to FIG. 1.

At block 405, the first device 120 obtains the first set of state-related metrics of the RAN 105 for the first time duration. At block 410, the first device 120 determines, based on the first set of state-related metrics of the RAN 105, the first plan for state transition of the RAN 105. The first plan comprises the first expected state of the RAN 105 for a time period. The first expected state will be used to determine a target state of the RAN 105 for the time period.

In some example embodiments, the first device 120 may send an indication of the first plan to the second device 125 to cause the second device 125 to determine the target state. For example, the indication of the first plan may comprise a mapping table storing mapping between the time period and the first expected state.

In some example embodiments, the first device 120 may send, to the second device 125, an indication of prioritization associated with the first expected state. The prioritization may be prioritization of the first expected state additionally indicated in the mapping table representing the first plan or the predefined prioritization of the first plan.

In some example embodiments, the first device 120 may comprise a Non-RT RIC.

FIG. 5 shows a flowchart of an example method 500 according to some other example embodiments of the present disclosure. The method 500 can be implemented at the second device 125 as shown in FIG. 1. For the purpose of discussion, the method 500 will be described with reference to FIG. 1.

At block 505, the second device 125 obtains the first plan for state transition of the RAN 105. The first plan is determined based on the first set of state-related metrics of the

RAN 105 for first time duration and comprises the first expected state of the RAN 105 for a time period. At block 510, the second device 125 obtains the second set of state-related metrics of the RAN for the second time duration shorter than the first time duration. At block 515, the second device 125 determines, from the first expected state, a target state of the RAN 105 for the time period. The determination of the target state is based on at least one of prioritization associated with the first expected state, or the second set of state-related metrics of the RAN 105.

In some example embodiments, the second device 125 may send, to the third device 110 in the RAN 105, an indication of the target state. Accordingly, the third device 110 may perform an act.

In some example embodiments, the second device 125 may determine the first plan by itself. In some other example embodiments, the second device 125 may receive an indication of the first plan from the first device 120. For example, the indication of the first plan may comprise a mapping table storing the mapping between the time period and the first expected state.

In some example embodiments, the second device 125 may determine, based on the prioritization associated with the first expected state, that the target state follows the first expected state. The prioritization may be the prioritization of the first plan that is predefined or the prioritization of the first expected state additionally indicated in the mapping table representing the first plan.

In some example embodiments, the second device 125 may determine, based on the second set of state-related metrics of the RAN 105 for the second time duration, the second plan for state transition of the RAN 105. The second plan comprises the second expected state of the RAN 105 for the time period. Then, the second device 125 may determine the target state of the RAN based on the first expected state, the second expected state and the third set of state-related metrics of the RAN for the third time duration shorter than the first time duration.

In some example embodiments, the second device 125 may comprise a Near-RT RIC.

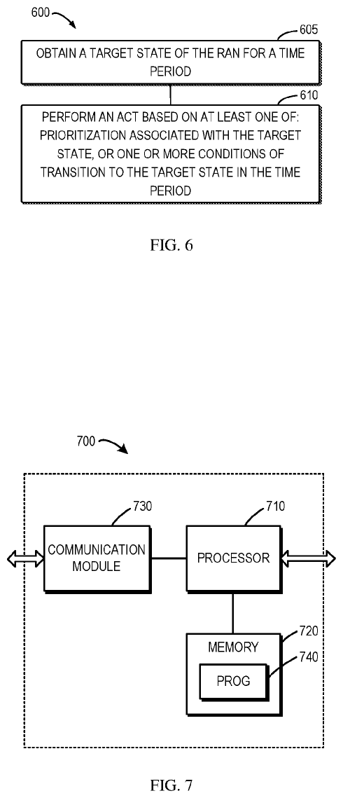

FIG. 6 shows a flowchart of an example method 600 according to yet some example embodiments of the present disclosure. The method 600 can be implemented at the third device 110 of the RAN 105 as shown in FIG. 1. For the purpose of discussion, the method 600 will be described with reference to FIG. 1.

At block 605, the third device 110 obtains the target state of the RAN 105 for a time period. At block 610, the third device 110 performs an act based on at least one of: prioritization associated with the target state, or one or more conditions of transition to the target state in the time period.

In some example embodiments, based on the prioritization associated with the target state, the third device 110 may determine that the target state is to be followed. Then, the third device 110 may switch to the target state in the time period.

In some example embodiments, the third device 110 may determine the target state by itself. In some example embodiments, the third device 110 may transmit the state-related metrics of the RAN 105 to the second device 125 so that the second device 125 may determine the target state. In some example embodiments, the third device 110 may receive an indication of the target state from the second device 125.

In some example embodiments, the third device 110 may transmit the state-related metrics of the RAN 105 to the first device 120 so that the first device 120 may determine the first expected state of the RAN 105 for the time period. Further, the first expected state may be used to determine the target state.

All operations and features as described above with reference to FIGS. 1 to 3 are likewise applicable to the methods 400, 500 and 600 and have similar effects. For the purpose of simplification, the details will be omitted.

FIG. 7 is a simplified block diagram of a device 700 that is suitable for implementing example embodiments of the present disclosure. The device 700 can be implemented at the first device 120, the second device 125 or the third device 110 as shown in FIG. 1.

As shown, the device 700 includes a processor 710, a memory 720 coupled to the processor 710, a communication module 730 coupled to the processor 710, and a communication interface (not shown) coupled to the communication module 730. The memory 720 stores at least a program 740. The communication module 730 is for bidirectional communications, for example. via multiple antennas or via a cable. The communication interface may represent any interface that is necessary for communication.

The program 740 is assumed to include program instructions that, when executed by the associated processor 710, enable the device 700 to operate in accordance with the example embodiments of the present disclosure, as discussed herein with reference to FIGS. 1 to 6. The example embodiments herein may be implemented by computer software executable by the processor 710 of the device 700, or by hardware, or by a combination of software and hardware. The processor 710 may be configured to implement various example embodiments of the present disclosure.

The memory 720 may be of any type suitable to the local technical network and may be implemented using any suitable data storage technology, such as a non-transitory computer readable storage medium, semiconductor based memory devices, magnetic memory devices and systems. optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

When the device 700 acts as the first device 120, the processor 710 may implement the operations or acts of the first device 12 as described above with reference to FIGS. 1-4. When the device 700 acts as the second device 125, the processor 710 may implement the operations or acts of the second device 125 as described above with reference to FIGS. 1-3 and 5. When the device 700 acts as the third device 110, the processor 710 may implement the operations or acts of the third device 110 as described above with reference to FIGS. 1-3 and 6. All operations and features as described above with reference to FIGS. 1 to 6 are likewise applicable to the device 700 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor. to carry out the operations and acts as described above with reference to FIGS. 1 to 6. Generally, program modules include routines, programs, libraries. objects, classes. components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a first device comprises: at least one processor; and at least one memory including computer program code; the at least one memory and the computer program code configured to, with the at least one processor, cause the first device to: obtain a first set of state-related metrics of a radio access network, RAN, for first time duration; and determine, based on the first set of state-related metrics of the RAN, a first plan for state transition of the RAN, the first plan comprising a first expected state of the RAN for a time period, the first expected state to be used to determine a target state of the RAN for the time period.

In some example embodiments, the first device is further caused to: send an indication of the first plan to a second device to cause the second device to determine the target state.

In some example embodiments, the first device is further caused to: send, to the second device, an indication of prioritization associated with the first expected state.

In some example embodiments, the indication of the first plan comprises a mapping table storing mapping between the time period and the first expected state and the prioritization associated with the first expected state.

In some example embodiments, the first device comprises a Non-Real-time RAN Intelligence Controller.

In some aspects, a second device comprises: at least one processor; and at least one memory including computer program code; the at least one memory and the computer program code configured to, with the at least one processor, cause the second device to: obtain a first plan for state transition of a radio access network, RAN, the first plan being determined based on a first set of state-related metrics of the RAN for first time duration, and the first plan comprising a first expected state of the RAN for a time period; obtain a second set of state-related metrics of the RAN for second time duration shorter than the first time duration; and determine, from the first expected state, a target state of the RAN for the time period, based on at least one of: prioritization associated with the first expected state, or the second set of state-related metrics of the RAN.

In some example embodiments, the second device is further caused to: send, to a third device in the RAN, an indication of the target state.

In some example embodiments, the second device is caused to obtain the first plan by: receiving an indication of the first plan from a first device.

In some example embodiments, the second device is further caused to: receive, from the first device, an indication of prioritization associate with the first expected state.

In some example embodiments, the indication of the first plan comprises a mapping table storing mapping between the time period and the first expected state and the prioritization associated with the first expected state.

In some example embodiments, the second device is caused to determine the target state by: determining, based on the prioritization associated with the first expected state, that the target state follows the first expected state.

In some example embodiments, the second device is caused to determine the target state by: determining, based on the second set of state-related metrics of the RAN for the second time duration, a second plan for state transition of the RAN, the second plan comprising a second expected state of the RAN for the time period; and determining the target state of the RAN based on the first expected state, the second expected state and a third set of state-related metrics of the RAN for third time duration shorter than the first time duration.

In some example embodiments, the second device comprises a Near-Real-Time RAN Intelligence Controller.

In some aspects, a third device comprises: at least one processor; and at least one memory including computer program code; the at least one memory and the computer program code configured to, with the at least one processor, cause the third device to: obtain a target state of the RAN for a time period; and perform an act based on at least one of: prioritization associated with the target state, or one or more conditions of transition to the target state in the time period.

In some example embodiments, the third device is caused to perform the act by: determining, based on the prioritization associated with the target state, that the target state is to be followed; and switching to the target state in the time period.

In some example embodiments, the third device is further caused to: receive, from a second device, an indication of the target state.

In some example embodiments, the third device is further caused to: transmit state-related metrics of the RAN to the second device for determining the target state.

In some example embodiments, the third device is further caused to: transmit state-related metrics of the RAN to a first device for determining a first expected state of the RAN for the time period, the first expected state to be used to determine the target state.

In some aspects, a method implemented at a first device comprises: obtaining a first set of state-related metrics of a radio access network, RAN, for first time duration; and determining, based on the first set of state-related metrics of the RAN, a first plan for state transition of the RAN, the first plan comprising a first expected state of the RAN for a time period, the first expected state to be used to determine a target state of the RAN for the time period.

In some example embodiments, the method further comprises: sending an indication of the first plan to a second device to cause the second device to determine the target state.

In some example embodiments, the method further comprises: sending, to the second device, an indication of prioritization associated with the first expected state.

In some example embodiments, the indication of the first plan comprises a mapping table storing mapping between the time period and the first expected state and the prioritization associated with the first expected state.

In some example embodiments, the first device comprises a Non-Real-time RAN Intelligence Controller.

In some aspects, a method implemented at a second device comprises: obtaining a first plan for state transition of a radio access network, RAN, the first plan being determined based on a first set of state-related metrics of the RAN for first time duration, and the first plan comprising a first expected state of the RAN for a time period; obtaining a second set of state-related metrics of the RAN for second time duration shorter than the first time duration; and determining, from the first expected state, a target state of the RAN for the time period, based on at least one of: prioritization associated with the first expected state, or the second set of state-related metrics of the RAN.

In some example embodiments, the method further comprises: sending, to a third device in the RAN, an indication of the target state.

In some example embodiments, obtaining the first plan comprises: receiving an indication of the first plan from a first device.

In some example embodiments, the method further comprises: receiving, from the first device, an indication of prioritization associate with the first expected state.

In some example embodiments, the indication of the first plan comprises a mapping table storing mapping between the time period and the first expected state and the prioritization associated with the first expected state.

In some example embodiments, determining the target state comprises: determining, based on the prioritization associated with the first expected state, that the target state follows the first expected state.

In some example embodiments, determining the target state comprises: determining, based on the second set of state-related metrics of the RAN for the second time duration, a second plan for state transition of the RAN, the second plan comprising a second expected state of the RAN for the time period; and determining the target state of the RAN based on the first expected state, the second expected state and a third set of state-related metrics of the RAN for third time duration shorter than the first time duration.

In some example embodiments, the second device comprises a Near-Real-Time RAN Intelligence Controller.

In some aspects, a method implemented at a third device comprises: obtaining a target state of the RAN for a time period; and performing an act based on at least one of: prioritization associated with the target state, or one or more conditions of transition to the target state in the time period.

In some example embodiments, performing the act comprises: determining, based on the prioritization associated with the target state, that the target state is to be followed; and switching to the target state in the time period.

In some example embodiments, the method further comprises: receiving, from a second device, an indication of the target state.

In some example embodiments, the method further comprises: transmitting state-related metrics of the RAN to the second device for determining the target state.

In some example embodiments, the method further comprises: transmitting state-related metrics of the RAN to a first device for determining a first expected state of the RAN for the time period, the first expected state to be used to determine the target state.

In some aspects, an apparatus implemented at a first device comprises: means for obtaining a first set of state-related metrics of a radio access network, RAN, for first time duration; and means for determining, based on the first set of state-related metrics of the RAN, a first plan for state transition of the RAN, the first plan comprising a first expected state of the RAN for a time period, the first expected state to be used to determine a target state of the RAN for the time period.

In some example embodiments, the apparatus further comprises: means for sending an indication of the first plan to a second device to cause the second device to determine the target state.

In some example embodiments, the apparatus further comprises: means for sending, to the second device, an indication of prioritization associated with the first expected state.

In some example embodiments, the indication of the first plan comprises a mapping table storing mapping between the time period and the first expected state and the prioritization associated with the first expected state.

In some example embodiments, the first device comprises a Non-Real-time RAN Intelligence Controller.

In some aspects, an apparatus implemented at a second device comprises: means for obtaining a first plan for state transition of a radio access network, RAN, the first plan being determined based on a first set of state-related metrics of the RAN for first time duration, and the first plan comprising a first expected state of the RAN for a time period; means for obtaining a second set of state-related metrics of the RAN for second time duration shorter than the first time duration; and means for determining, from the first expected state, a target state of the RAN for the time period, based on at least one of: prioritization associated with the first expected state, or the second set of state-related metrics of the RAN.

In some example embodiments, the apparatus further comprises: means for sending, to a third device in the RAN, an indication of the target state.

In some example embodiments, the means for obtaining the first plan comprises: means for receiving an indication of the first plan from a first device.

In some example embodiments, the apparatus further comprises: means for receiving, from the first device, an indication of prioritization associate with the first expected state.

In some example embodiments, the indication of the first plan comprises a mapping table storing mapping between the time period and the first expected state and the prioritization associated with the first expected state.

In some example embodiments, the means for determining the target state comprises: means for determining. based on the prioritization associated with the first expected state, that the target state follows the first expected state.

In some example embodiments, the means for determining the target state comprises: means for determining, based on the second set of state-related metrics of the RAN for the second time duration, a second plan for state transition of the RAN, the second plan comprising a second expected state of the RAN for the time period; and means for determining the target state of the RAN based on the first expected state, the second expected state and a third set of state-related metrics of the RAN for third time duration shorter than the first time duration.

In some example embodiments, the second device comprises a Near-Real-Time RAN Intelligence Controller.

In some aspects, an apparatus implemented at a third device comprises: means for obtaining a target state of the RAN for a time period; and means for performing an act based on at least one of: prioritization associated with the target state, or one or more conditions of transition to the target state in the time period.

In some example embodiments, the means for performing the act comprises: means for determining, based on the prioritization associated with the target state, that the target state is to be followed; and switching to the target state in the time period.

In some example embodiments, the apparatus further comprises: means for receiving, from a second device, an indication of the target state.

In some example embodiments, the apparatus further comprises: means for transmitting state-related metrics of the RAN to the second device for determining the target state.

In some example embodiments, the apparatus further comprises: means for transmitting state-related metrics of the RAN to a first device for determining a first expected state of the RAN for the time period, the first expected state to be used to determine the target state.

In some aspects, a computer readable storage medium comprises program instructions stored thereon, the instructions, when executed by a processor of a device, causing the device to perform the method according to some example embodiments of the present disclosure.

1-40. (canceled)

41. A first device comprising:
at least one processor; and
at least one memory including computer program code;
the at least one memory and the computer program code configured to, with the at least one processor, cause the first device to:
obtain a first set of state-related metrics of a radio access network, RAN, for first time duration; and
determine, based on the first set of state-related metrics of the RAN, a first plan for state transition of the RAN, the first plan comprising a first expected state of the RAN for a time period, the first expected state to be used to determine a target state of the RAN for the time period.

42. The first device of claim 41, wherein the first device is further caused to:
send an indication of the first plan to a second device to cause the second device to determine the target state.

43. The first device of claim 42, wherein the first device is further caused to:
send, to the second device, an indication of prioritization associated with the first expected state.

44. The first device of claim 43, wherein the indication of the first plan comprises a mapping table storing mapping between the time period and the first expected state and the prioritization associated with the first expected state.

45. The first device of claim 41, wherein the first device comprises a Non-Real-time RAN Intelligence Controller.

46. A method implemented at a first device, the method comprising:
obtaining a first set of state-related metrics of a radio access network, RAN, for first time duration; and
determining, based on the first set of state-related metrics of the RAN, a first plan for state transition of the RAN, the first plan comprising a first expected state of the RAN for a time period, the first expected state to be used to determine a target state of the RAN for the time period.

47. The method of claim 46, further comprising:
sending an indication of the first plan to a second device to cause the second device to determine the target state.

48. The method of claim 47, further comprising:
sending, to the second device, an indication of prioritization associated with the first expected state.

49. The method of claim 48, wherein the indication of the first plan comprises a mapping table storing mapping between the time period and the first expected state and the prioritization associated with the first expected state.

50. The method of claim 46, wherein the first device comprises a Non-Real-time RAN Intelligence Controller.

51. A computer readable storage medium comprising program instructions stored thereon, the instructions, when executed by a processor of a device, causing the device to perform:
obtaining a first set of state-related metrics of a radio access network, RAN, for first time duration; and
determining, based on the first set of state-related metrics of the RAN, a first plan for state transition of the RAN, the first plan comprising a first expected state of the RAN for a time period, the first expected state to be used to determine a target state of the RAN for the time period.
